(19) United States
(12) Patent Application Publication
(10) Pub. No.: US 2012/0188550 A1
(43) Pub. Date: Jul. 26, 2012

(54) Gas Concentration Measurement Device

(75) Inventor: Naoki MATSUDA, Nara-shi (JP)

(73) Assignee: SHIMADZU CORPORATION, Kyoto-shi (JP)

(21) Appl. No.: 13/190,307

(22) Filed: Jul. 25, 2011

(30) Foreign Application Priority Data
Jul. 27, 2010 (JP) 2010-167769

(51) Int. Cl. G01N 21/61

(52) U.S. Cl. 356/437

(57) ABSTRACT

In a gas concentration measurement device using a TDLAS measurement, the distortion of peak waves originating from absorption by target components is prevented by reducing a higher-frequency noise signal which occurs in an output of a digital phase-sensitive detection process at the moment of switching the wavelength in a saw-tooth-formed wavelength-sweep operation. A modulating current having a predetermined frequency for component detection and a drive current having a saw-tooth form for wavelength-sweep are superimposed and supplied to a first laser diode (LD) 1, while a drive current having an inverted saw-tooth form, which changes in synchronization with the saw-tooth drive current and in the opposite direction, is supplied to a second LD 5. Laser beams emitted from the LDs 1 and 5 are respectively attenuated by ND filters 3 and 7 (for light-amount adjustments), and mixed by a half mirror 4, to be thrown into a measurement cell 9 filled with a gas to be analyzed. After undergoing absorption at a wavelength specific to a target component in the gas, the mixed laser beam is detected by a photodetector 10. The changes in the amount of light of the two laser beams associated with the wavelength-sweep operation cancel each other, whereby a step-like change which occurs in the output of the photodetector 10 at the moment of switching the wavelength is reduced. As a result, the occurrence of the higher-frequency noise is prevented in the phase-sensitive detection process.

### TECHNICAL FIELD

The present invention relates to a gas concentration measurement device for measuring the concentration of a specific component contained in a gas by using absorption of laser light by the gas, and more specifically to a gas concentration measurement device using a tunable diode laser absorption spectroscopy measurement.

### BACKGROUND ART

As one method for measuring gas concentration, a technique called the Tunable Diode Laser Absorption Spectroscopy measurement (which is hereinafter abbreviated as the “TDLAS” measurement) has been widely known (for example, refer to Patent Document 1 or Non-Patent Document 1). In a typical TDLAS measurement, a modulated laser beam of predetermined frequency f is thrown into a measurement cell filled with a gas to be analyzed, and the intensity of the laser beam that has passed through the gas is detected by a photodetector. A variety of components contained in the gas respectively absorb light at specific wavelengths. Therefore, when the wavelength of the laser beam is swept at a frequency sufficiently lower than the modulation frequency f, a strong absorption of the laser beam occurs at around a frequency characteristic of a target component in the gas. This absorption emerges as a harmonic component of the modulation frequency f. Accordingly, a phase-sensitive detection for extracting a harmonic component of the modulation frequency f (typically, the second harmonic component) contained in the detection signal produced by the photodetector is performed, and the concentration of the target component in the gas being analyzed is determined from the magnitude of the extracted component.

The TDLAS measurement is a non-contact measurement in which the photodetector and other detection elements do not come in contact with the gas being analyzed. Therefore, the measurement can be performed without disturbing the gas field. This method also has the advantages that its extremely short response time enables an approximately real-time measurement of the gas concentration, and its measurement sensitivity is high.

Although the phase-sensitive detection in the TDLAS measurement can be achieved by analogue signal processing, the recent advancement in digital signal processing techniques has also made it possible to perform the phase-sensitive detection by digital signal processing (for example, refer to Non-Patent Document 2). In the phase-sensitive detection using digital signal processing, a detection signal is multiplied by a reference signal having a frequency twice as high as the modulation frequency f, after which unnecessary AC components are removed by means of a digital filter. Digital filters can be roughly grouped into FIR (Finite Impulse Response) and HR (Infinite Impulse Response) types of filters. IIR filters have an advantage in that a high level of filtering effect can be achieved with a small circuit size. For this reason, an IIR filter is used for the phase-sensitive detection in the device described in Non-Patent Document 2. IIR filters are a recursive filter in which the result of the previous filtering computation is fed back to an input of the same filter. Accordingly, when a large noise unrelated to the measurement comes in the detection signal, a significant error may arise in the computed result since the result of the computation involving the noise is repeatedly used in the subsequent computations.

In the TDLAS measurement, in most cases, the wavelength of the laser beam is repeatedly changed to sweep a relatively narrow range spanning λ1 to λ2 around the absorption wavelength λ of a target component in the gas, as shown in FIG. 7, in order to continuously measure the concentration of that component in approximately real time. The repetition frequency of the wavelength-sweep operation is determined according to the response time and/or resolving power of the measurement. The modulation frequency f is set to be 1000 times the wavelength-sweep frequency or higher. For this wavelength-sweep operation, the drive current supplied to the tunable diode laser is changed in a saw-tooth form. In the tunable diode laser, not only the oscillation wavelength but also the emission intensity depends on the drive current. Accordingly, when the drive current is changed in a saw-tooth form for the wavelength-sweep operation, the detection signal produced by the photodetector (the intensity of the received light) also changes in a roughly saw-tooth form, as shown in FIG. 8A.

For a detection signal that steeply changes at the moment of switching the wavelength (from the wavelength at which one sweep cycle is completed to the wavelength at which the next cycle begins) during the wavelength-sweep operation, if a phase-sensitive detection is performed to extract a harmonic component of the modulation frequency f, an impulsive noise which occurs at the moment of the wavelength-switching may emerge as a noise signal having a higher frequency along with a peak wave originating from the absorption by the target component, as shown in FIG. 8B. If such a higher-frequency noise is repeatedly fed back to the IIR filter used for the phase-sensitive detection, the noise may possibly affect the filtering process for a considerable period of time and distort the shape of the peak wave originating from the absorption by the target component, thereby constituting a major cause of a concentration error.

### BACKGROUND ART DOCUMENT

### Patent Document

Patent Document 1: JP-AH09-33430

### Non-Patent Document

Non-Patent Document 1: J. Reid and D. Labrie, “Second-Harmonic Detection with Tunable Diode Lasers—Comparison of Experiment and Theory”, Appl. Phys., B26, 1981, pp. 203-210

Non-Patent Document 2: N. Matsuda et al., “Reeza Kyuukou Bunkou-hou Wo Mochiita Kousoku Koukando Gasu Keisoku Souchi No Kaihatsu (Development of High-Speed and High-Sensitivity Gas Measurement System using Laser Absorption Spectroscopy)”, Shimadzu Hyouron (Shimadzu Review), Shimadzu Hyouron Henshuu-bu, Sep. 30, 2009, Vol. 66, No. 1/2, pp. 45-51

### DISCLOSURE OF THE INVENTION

### Problem to be Solved by the Invention

The present invention has been developed in view of the previously described problems, and its objective is to provide a gas concentration measurement device using a TDLAS measurement in which an impulsive noise signal arising from a wavelength sweep during the phase-sensitive detection process is suppressed so that peak information which correctly reflects the concentration of a target component in a gas can be extracted and the gas concentration can be accurately determined from that information.

### Means for Solving the Problems

The present invention aimed at solving the aforementioned problem is a gas concentration measurement device for measuring a concentration of a specific component in a gas by a tunable diode laser absorption spectrometry measurement, including:

a) a plurality of laser sources, including a first laser source having a variable wavelength;

b) a laser drive controller for supplying a drive current to the first laser source so as to modulate an oscillation wavelength of the first laser source at a predetermined modulation frequency and repeatedly sweep, in a predetermined waveform, a predetermined wavelength range including an absorption wavelength of a target component, and for supplying a drive current to another one of the laser sources so as to change an amount of emission of this other one of the laser sources in an inverse waveform in which the amount of emission repeatedly changes in synchronization with a wavelength sweep in the predetermined waveform and with a growing manner opposite to a change in the amount of emission associated with the wavelength sweep;

c) a measurement cell for holding a gas to be analyzed, the measurement cell being positioned so that a laser beam emitted from the first laser source is thrown into the measurement cell;

d) a light mixer for mixing a plurality of laser beams respectively emitted from the plurality of laser sources to be thrown into the measurement cell, or for mixing a plurality of laser beams respectively emitted from the plurality of laser sources including at least one laser beam that has passed through the measurement cell and at least one laser beam that has bypassed the measurement cell;

e) a photodetector for receiving a mixed laser beam produced by the light mixer, the mixed laser beam being composed of a plurality of laser beams respectively emitted from the plurality of laser sources, with at least one laser beam passing through the measurement cell; and

f) a demodulator for extracting a fundamental component of the modulation frequency or a harmonic component of the modulation frequency by phase-sensitive detection from a detection signal obtained with the photodetector,

where the change in the amount of emission associated with the wavelength sweep in the predetermined waveform and the change in the amount of emission in the inverse waveform cancel each other at a stage where the laser beams are mixed by the light mixer and the mixed laser beam is received by the photodetector, so that an output change corresponding to the wavelength sweep is smoothed at an output stage of the photodetector.

In a typical mode of the gas concentration measurement device according to the present invention, the change in the amount of emission associated with the sweep of the oscillation wavelength of the first laser source is made to occur in a saw-tooth form, while the change in the amount of emission of the aforementioned other one of the laser sources is made to occur in an inverted saw-tooth form which has an opposite changing direction. That is to say, the “predetermined waveform” may be a saw-tooth form and the “inverse waveform” may be an inverse saw-tooth form.

In the case where the gas concentration measurement device according to the present invention is used to measure the concentration of only one target component, it is necessary to use only two laser sources including one laser source having a variable wavelength. In this case, the laser drive controller supplies a drive current to a first laser source having a variable wavelength so as to modulate the oscillation wavelength of the first laser source at a predetermined modulation frequency and repeatedly sweep, in a predetermined waveform (e.g. a saw-tooth form) and at a frequency lower than the modulation frequency, a predetermined wavelength range including an absorption wavelength of a target component, and also supplies a drive current to a second laser source so as to change the amount of emission of the second laser sources in an inverted saw-tooth form in which the amount of emission repeatedly changes in synchronization with the wavelength sweep in the saw-tooth form and in an opposite direction to a change in the amount of emission associated with the wavelength sweep. In this case, the second laser source does not need to have a variable wavelength; it may be a fixed-wavelength type. Even when the second laser source is a variable-wavelength type, it is unnecessary to modulate its output beam. Furthermore, even when the second laser source is a variable-wavelength type and the amount of emission is changed by a wavelength-sweep operation in an inverted saw-tooth form, its wavelength-sweeping range may be different from that of the saw-tooth wavelength-sweep operation performed by the first laser source.

If the first and second laser sources have sufficiently equal light-emitting characteristics, such as the amount of emission (power) relative to the drive current and the current-to-emission conversion efficiency (slope efficiency), and if the wavelength-photosensitivity characteristic of the photodetector can be regarded as constant, an output change associated with a saw-tooth change in the amount of emission and an output change associated with an inverted saw-tooth change in the amount of emission substantially cancel each other at the stage where the two laser beams respectively emitted from the first and second laser sources are mixed together as well as at the stage where the mixed laser beam enters the photodetector and undergoes photoelectric conversion, since the two kinds of saw-tooth changes in the amount of emission are opposite to each other. Particularly, the DC level of the output becomes approximately constant because the step-like change which occurs in the output at the moment of switching the wavelength in the wavelength-sweep operation is reduced. Naturally, the objective signal component remains unchanged since the aforementioned cancellation has no impact on the change in the amount of light associated with the frequency modulation of the oscillation wavelength of the laser sources or the change in the amount of light due to the absorption by a component in the gas to be analyzed.

However, in some cases, it is difficult to prepare a plurality of laser sources having sufficiently equal light-emitting characteristics. It is also difficult to create a photodetector whose wavelength-photosensitivity characteristic is constant irrespective of the wavelength. Given these factors, in one preferable mode of the gas concentration measurement device according to the present invention, a light attenuator for reducing the amount of light is provided between at least one of the laser sources and the light mixer located before the measurement cell or between the measurement cell and the light mixer located after this measurement cell, so that the output change associated with the wavelength sweep is smoothed at the output stage of the photodetector. For example, a neutral density (ND) filter is available as the light attenuator.

In this mode, the amount of light of at least one laser beam is appropriately controlled before the plurality of laser beams are mixed by the light mixer, so as to reduce the influence of the difference in the light-emitting characteristic of the laser sources or the unevenness in the wavelength-photosensitivity characteristic of the photodetector, whereby the change in the DC level of the output associated with the switching of the wavelength in the wavelength-sweep operation is sufficiently reduced at the output stage of the photodetector. The light attenuator is also useful for adjusting the entire amount of light in the case where mixing (or adding) the laser beams by the light mixer produces an excessively strong laser beam that can saturate the output of the photodetector.

To simultaneously measure the concentrations of two (first and second) target components contained in a gas to be analyzed, the gas concentration measurement device according to the present invention may be constructed so that the plurality of laser sources are two, first and second laser sources each having a variable wavelength, the laser drive controller supplies a drive current to the second laser source so as to modulate an oscillation wavelength of the second laser source at a second modulation frequency different from the aforementioned predetermined modulation frequency and repeatedly sweep a predetermined wavelength range including an absorption wavelength of a second target component, and the gas concentration measurement device includes a second demodulator for extracting a fundamental component of the second modulation frequency or a harmonic component of the second modulation frequency by phase-sensitive detection from a detection signal obtained with the photodetector.

A simultaneous measurement of the concentrations of three or more target components contained in a gas can also be similarly achieved by a configuration as follows:

the same number of wavelength-variable laser sources as the number of the target components are provided;

drive currents are supplied to the laser sources so that the oscillation wavelength of each of the laser sources is modulated at a different modulation frequency and a predetermined wavelength range including an absorption wavelength of each of the components is repeatedly swept, wherein the wavelength-changing direction in a wavelength-sweep operation for at least one of the laser sources is opposite to the wavelength-changing direction for the other laser sources;

the laser beams from the laser sources are mixed after the amount of light of each of the laser beams is appropriately adjusted by a light attenuator; and

the mixed laser beam is thrown into the measurement cell,

wherein an output change associated with the switching of the wavelength in the wavelength-sweep operation is sufficiently reduced at an output stage of a photodetector.

### Effects of the Invention

In the gas concentration measurement device according to the present invention, the steep change in the signal of the photodetector at the moment of switching the wavelength in the wavelength-sweep operation is reduced and smoothed, whereby an impulsive noise signal having a higher frequency is prevented from emerging in an output of the phase-sensitive detection process. Therefore, even when the phase-sensitive detection process is performed using an HR-type digital filter, the peak wave originating from absorption by a target component will not be distorted due to the influence of the higher-frequency noise, so that the concentration of the target component can be calculated with high accuracy.

Furthermore, in the gas concentration measurement device according to the present invention, a plurality of multiplexed (wavelength-division multiplexed) laser beams which are generated for simultaneously measuring the concentrations of a plurality of target components, can be effectively utilized to reduce and smooth the steep change in the output of the photodetector at the moment of switching the wavelength in the wavelength-sweep operation. Accordingly, both the simultaneous measurement of multiple components and the removal of higher-frequency noises at the moment of the wavelength-switching can be achieved with only a relatively simple configuration and a minor increase in cost.

### BRIEF DESCRIPTION OF THE DRAWINGS

FIG. 1 is a schematic configuration diagram of a gas concentration measurement device according to one embodiment of the present invention.

FIG. 2 is a schematic configuration diagram showing a variation of the gas concentration measurement device shown in FIG. 1.

FIG. 3 is a diagram illustrating the principle of the noise reduction by the gas concentration measurement device according to the present invention.

FIGS. 4A and 4B are waveform diagrams showing an output waveform of a photodetector and a phase-sensitive detection output waveform in the gas concentration measurement device according to the present embodiment.

FIG. 5 is a schematic configuration diagram of a gas concentration measurement device according to another embodiment of the present invention.

FIG. 6 is a schematic configuration diagram showing a variation of the gas concentration measurement device shown in FIG. 2.

FIG. 7 is a graph schematically showing a temporal change in the oscillation frequency of a tunable diode laser during a wavelength-sweep operation.

FIGS. 8A and 8B are waveform diagrams showing an output waveform of a photodetector and a phase-sensitive detection output waveform in a conventional gas concentration measurement device.

### BEST MODE FOR CARRYING OUT THE INVENTION

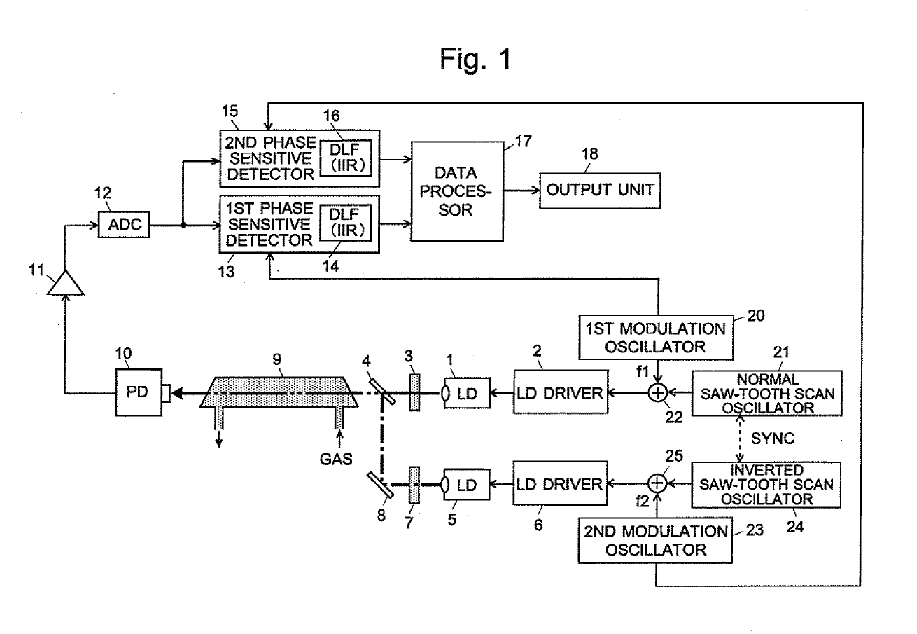

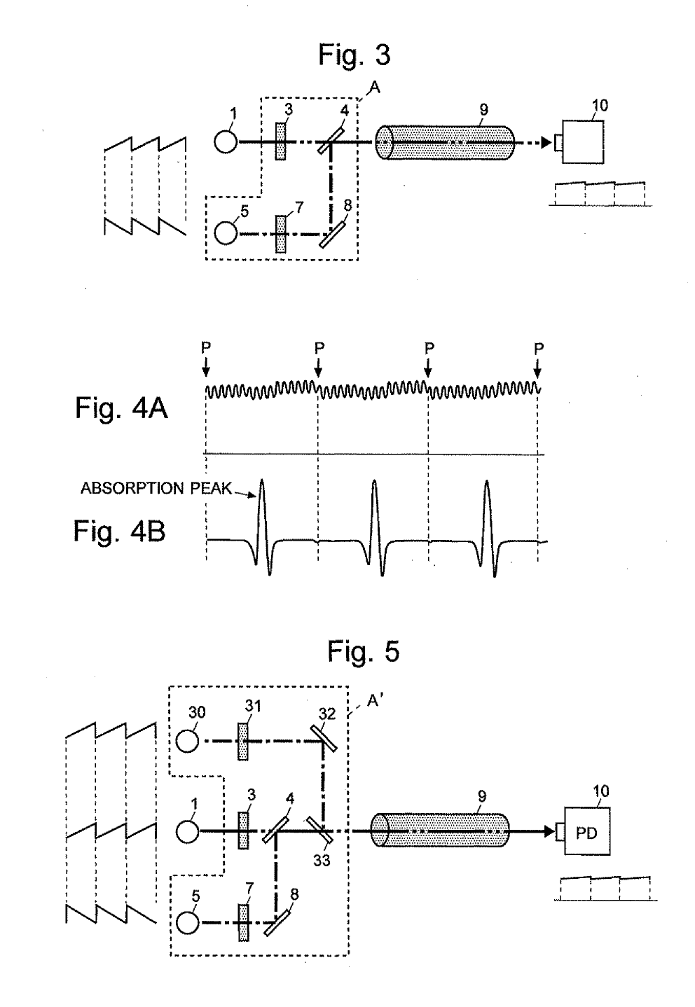

One embodiment of the gas concentration measurement device according to the present invention is hereinafter described with reference to the attached drawings. FIG. 1 is a configuration diagram showing the main components of the gas concentration measurement device of the present embodiment. Initially, the principle of reducing a higher-frequency noise signal emerging in a phase-sensitive detection output associated with a wavelength sweep in the gas concentration measurement device of the present embodiment is described by means of FIGS. 3, 4A and 4B. FIG. 3 is a schematic configuration diagram showing an optical system of the gas concentration measurement device according to the present embodiment. FIGS. 4A and 4B are waveform diagrams showing an output of a photodetector and a phase-sensitive detection output.

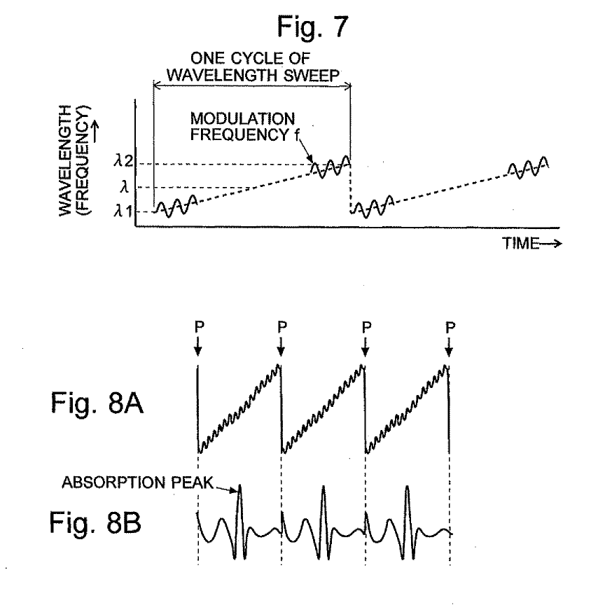

In a conventional gas concentration measurement device for a TDLAS measurement, as shown in FIG. 7, if the oscillation wavelength of the laser beam is changed in a saw-tooth form so as to repeatedly sweep a predetermined wavelength range, the output of a photodetector greatly changes in a step-like form when one wavelength-sweep cycle is completed and the next cycle begins, which results in an emergence of a higher-frequency noise in the phase-sensitive detection output. This conversely means that the generation of this higher-frequency noise signal can be suppressed by reducing and smoothing the step-like change in the output of the photodetector (i.e. by reducing the fluctuation in the DC level of the output). It should be noted that, in the TDLAS measurement, even if the step-like change in the DC level occurring in the output of the photodetector is reduced, none of the necessary information will be lost since the degree of absorption by a target component is reflected in the magnitude of a harmonic component of the modulation frequency, or more simply speaking, in the degree of distortion of the waveform of the modulating signal.

In FIG. 3, the parts added in the device according to the present embodiment are enclosed in broken line A. If these parts are removed, the remaining configuration will be a conventional device, which functions as follows: A first tunable laser diode 1 (which is hereinafter abbreviated as the first LD 1) is supplied with an electric current from an LD driver (not shown). This current is produced by superimposing a modulation current of frequency f on a saw-tooth drive current for performing a wavelength-sweep operation in the increasing direction of the wavelength. As a result of this current supply, the oscillation wavelength of the first LD 1 changes as shown in FIG. 7. A laser beam generated by the first LD 1 in this manner is thrown into a measurement cell 9, into which a gas to be analyzed is continuously supplied. While passing through this measurement cell 9, the laser beam undergoes absorption by the components contained in the gas. The laser beam that has undergone the absorption reaches a photodetector (PD) 10, such as an InGaAs photodiode. The photodetector 10 outputs a current signal corresponding to the intensity of the received light. The emission intensity of the first LD 1 changes as shown in FIG. 7 since not only the emission intensity of the first LD 1 but also its oscillation depends on the supplied current. Accordingly, the detection output of the photodetector 10 will be as shown in FIG. 8A.

In the gas concentration measurement device of the present embodiment, a first ND filter 3 and a half mirror 4 are provided between the first LD 1 and the measurement cell 9. A laser beam emitted from the first LD 1 passes through the first ND filter 3 and the half mirror 4 before reaching the measurement cell 9. The present device is additionally provided with a second tunable laser diode 5 (second LD 5), a second ND filter 7 and a mirror 8. A laser beam emitted from the second LD 5 passes through the second ND filter 7 and is totally reflected by the mirror 8. A portion of the totally reflected light is reflected by the half mirror 4, to be mixed with (added to) the other laser beam coming from the first LD 1. The mixed beam is thrown into the measurement cell 9. The second LD 5 is supplied with a drive current from an LD driver (not shown). This drive current is an inverted saw-tooth drive current, which is synchronized with the aforementioned saw-tooth drive current for the wavelength-sweep operation supplied to the first LD 1. The inverted saw-tooth drive current is changed so as to perform a wavelength-sweep operation in the decreasing direction of the wavelength, i.e. in the direction opposite to the saw-tooth drive current. No modulating current is superimposed on the inverted saw-tooth drive current. The “synchronization” in the present description means that the wavelength-sweep operation is performed at completely the same frequency and with the same phase. In other words, the timing of beginning or ending each sweeping cycle is identical; the only difference exists in the changing direction of the wavelength. The wavelength-sweep range for the second LD 5 may be the same as or different from that of the wavelength-sweep range for the first LD 1.

Similar to the case of the first LD 1, the emission intensity of the second LD 5 also depends on the supplied current. Accordingly, the emission intensity of the second LD 5 changes in an inverted saw-tooth form, as shown in the left part of FIG. 3. The saw-tooth change in the emission intensity of the first LD 1 and the inverted saw-tooth change in the emission intensity of the second LD 5 are identical to each other in terms of their cycle and phase and opposite to each other in terms of their changing directions. Therefore, when the two laser beams are added at the half mirror 4, the changes in their intensities cancel each other. However, if there is a difference in the emission characteristics between the first LD 1 and second LD 5, more specifically in the absolute amount of emission or the current-to-emission conversion efficiency (slope efficiency), or if the wavelength-photosensitivity characteristic of the photodetector 10 is uneven within the wavelength-sweep range, it is impossible to sufficiently reduce the signal change associated with the wavelength-sweeping operation in the output of the photodetector 10 by merely mixing the laser beam from the first LD 1 with the laser beam from the second LD 5. To address this problem, the light-attenuating characteristics of the first and second ND filters 3 and 7 are previously determined, taking into account the absolute amount of emission and the efficiency of conversion from the current to the amount of emission of the first LD 1 and the second LD 5, the wavelength-photosensitivity characteristic of the photodetector 10 and other factors, so as to sufficiently reduce the change in the output signal of the photodetector 10 at the moment of the wavelength-switching. In practice, the light-attenuating characteristic of each of the first and second ND filters 3 and 7 can be experimentally determined beforehand.

By appropriately determining the light-attenuating characteristic of each of the ND filters 3 and 7, the steep change in the output of the photodetector 10 at the moment of switching the wavelength in the wavelength-sweep operation can be significantly reduced, as shown in FIG. 4A. In the example shown in FIG. 4A, a slight, step-like change in the DC level at the moment of the wavelength-switching still remains. However, this will cause no substantial problem as long as no noticeable noise appears in the phase-sensitive detection output. That is to say, it is not always necessary to smooth the output level of the photodetector 10 to the extent that the wavelength-switching points in the output signal are not identifiable at all; the output signal can be considered to be smooth even if a step-like change slightly remains in the DC level. The number of ND filters, which is two in the present example (i.e. the ND filters 3 and 7), can be appropriately changed in accordance with the extent to control the light-attenuating characteristic. For example, it may be unnecessary to attenuate any laser beam, or it may be sufficient to provide only one ND filter in one of the two optical paths. Conversely, it is possible to combine two or more ND filters if an adequate light-attenuating effect cannot be achieved by one ND filter. This also holds true for the other embodiments, which will be described later.

Next, the configuration and operation of the gas concentration measurement device shown in FIG. 1 using the previously described principle are described. This gas concentration measurement device is designed to simultaneously measure the concentration of carbon monoxide (CO) as the primary target component and the concentration of another (secondary) target component (e.g. carbon dioxide: CO₂).

In the gas concentration measurement device of the present embodiment, the first LD 1 and the second LD 5 are DFB (Distributed FeedBack) lasers having oscillation wavelengths within the range from the near-infrared to mid-infrared regions. However, this type is not the only possible choice. A first modulation oscillator 20 generates a modulating current having a first modulation frequency f1. A normal saw-tooth scan oscillator 21 generates a saw-tooth drive current for sweeping a predetermined wavelength range from λ1 to λ2 around λ0=2.33 μm, which is an absorption wavelength for CO. These currents are superimposed on each other by an adder 22 and supplied to the first LD 1 via the LD driver 2. On the other hand, a second modulation oscillator 23 generates a modulating current having a second modulation frequency f2, which differs from the first modulation frequency f1. An inverted saw-tooth scan oscillator 24 generates an inverted saw-tooth drive current for sweeping a predetermined wavelength range from λ4 to λ5 around an absorption wavelength λ3 of the secondary target component in the decreasing direction of the wavelength with a timing synchronized with the normal saw-tooth drive current. These currents are added by an adder 25 and supplied to the second LD 5 via the LD driver 6. As already noted, the light-attenuating characteristics of the ND filters 3 and 7 are appropriately determined beforehand taking into account the emission characteristics of the LDs 1 and 5, the wavelength-photosensitivity characteristic of the photodetector 10 within the wavelength ranges λ1-λ2 and λ4-λ5, and other factors.

As described previously, the laser beam emitted from the first LD 1 and passing through the first ND filter 3 and the half mirror 4, and the laser beam emitted from the second LD 5 and reflected by the half mirror 4 by way of the second ND filter 7 and the mirror 8, are mixed together and thrown into the measurement cell 9 in which a gas to be analyzed is flowing. While passing through the measurement cell 9, the laser beam undergoes absorption by the component contained in the gas. If the primary target component, CO, is contained in the gas, the light is absorbed at around λ0=2.33 μm. If the secondary target component is contained in the gas, the light of wavelength λ3 is absorbed. After undergoing such absorptions, the laser beam reaches the photodetector 10, which produces a current signal corresponding to the intensity of the received light. As explained earlier, the laser beam generated by the first LD 1 supplied with the saw-tooth drive current, and the laser beam generated by the second LD 5 supplied with the inverted saw-tooth drive current, are appropriately attenuated and mixed together. As a result, the DC level of the output of the photodetector 10 is approximately smoothed, with only minor step-like changes associated with the switching of the wavelength remaining in the output. Naturally, the signals having the frequencies f1 and f2 as well as the decrease in the intensity of the received light due to absorption at around the wavelength λ0 or λ3 do not undergo any influence of the light-mixing process and will be properly reflected in the output of the photodetector 10.

The current signal produced by the photodetector 10 is sent to an amplifier 11, which converts the current signal into a voltage signal and amplifies this voltage signal. The amplified signal is converted into digital values (detection data) at predetermined sampling intervals by an analogue-to-digital converter (ADC) 12. These digital values are sent to a first phase-sensitive detector 13 and a second phase-sensitive detector 15 in parallel. The phase-sensitive detectors 13 and 15, each of which is composed of a digital lock-in detector and other elements, respectively includes IIR-type digital low-pass filters (DLF) 14 and 16. The first phase-sensitive detector 13 receives, from the first modulation oscillator 20, a reference signal having a frequency twice as high as the modulation frequency f1, and extracts, from the detection data, peak signals corresponding to the frequency of this reference signal, i.e. the second harmonic component whose frequency component is twice as high as the modulation frequency f1, while removing the other harmonic components by the DLF 14. Meanwhile, the second phase-sensitive detector 15 receives, from the second modulation oscillator 23, a reference signal having a frequency twice as high as the modulation frequency f2, and extracts, from the detection data, peak signals corresponding to the frequency of this reference signal, i.e. the second harmonic component whose frequency component is twice as high as the modulation frequency f2, while removing the other harmonic components by the DLF 16.

A data processor 17, which includes a peak detector, a calibration memory, a gas concentration converter and other components, calculates the height of each of the peak signals originating from the absorption by the target components and extracted by the phase-sensitive detector 13 or 15, and calculates the concentration of the primary and secondary target components from the heights of those peaks. The calculated concentration values are outputted through an output unit 18.

In the gas concentration measurement device according to the present invention, as shown in FIG. 4A, no major step-like change associated with the wavelength-switching occurs in the output of the photodetector 10, so that no impulsive higher-frequency noise occurs in the output of the phase-sensitive detectors 13 and 15 at the moment of the wavelength-switching. Therefore, even if this output is fed back to the input of the DLF 14 or 16, there will be no significant impact on the filtering process, and hence no distortion of the waveform of the peak originating from the absorption by the target component. The heights of the absorption peaks due to the primary and secondary target components correctly reflect the concentrations of the respective target components, thereby enabling an accurate calculation of the gas concentrations.

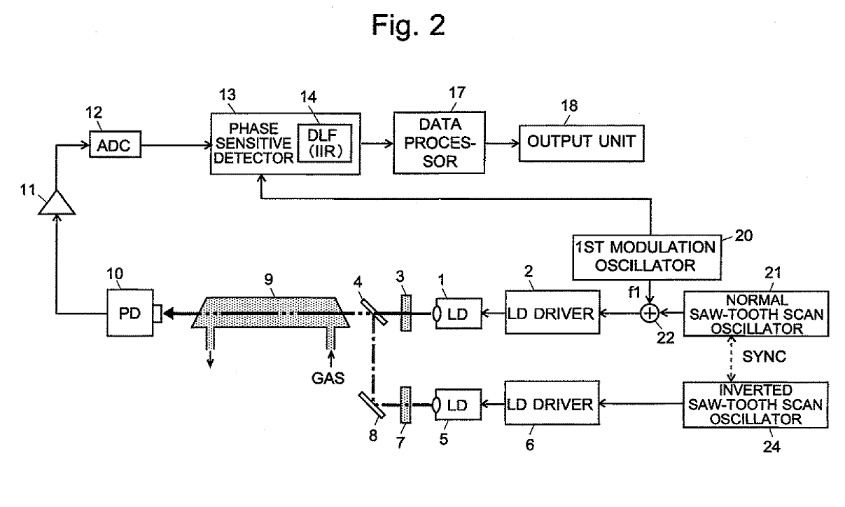

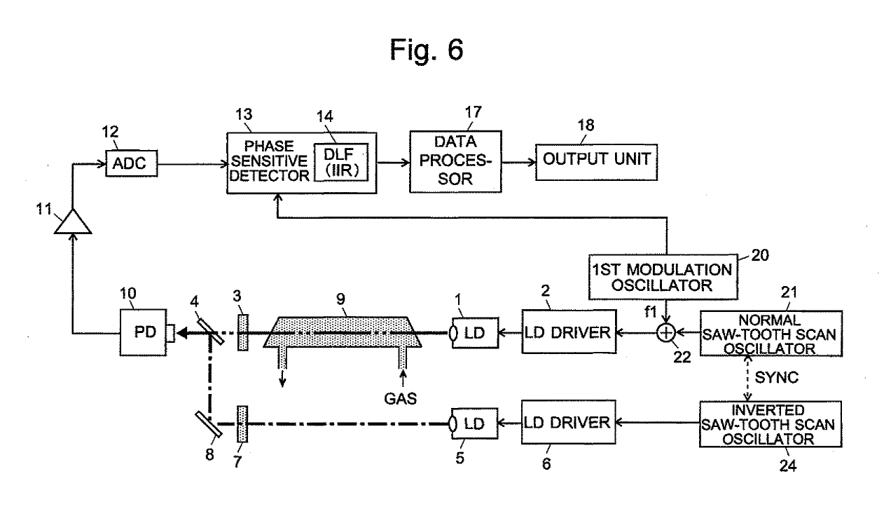

When the original purpose of the measurement is not to determine the concentrations of plural components in a gas but the concentration of one specific component in the gas, the device configuration can be changed as shown in FIG. 2 or FIG. 6. That is to say, the second modulation oscillator 23, the adder 25 and the second phase-sensitive detector 15 are unnecessary. In this case, only the inverted saw-tooth drive current for the wavelength-sweep operation is supplied to the second LD 5, and the laser beam emitted from the second LD 5 is unmodulated. In such a case, the wavelength-sweep range for the second LD 5 may be the same as the range for the first LD 1. This design makes it unnecessary to consider the wavelength-photosensitivity characteristic of the photodetector 10 in determining the light-attenuating characteristics of the ND filters 3 and 7.

In the configuration of FIG. 2, similar to the configuration of FIG. 1, the laser beam emitted from the second LD 5 also passes through the measurement cell 9. By contrast, in the configuration of FIG. 6, the laser beam emitted from the second LD 5 enters the photodetector 10 without passing through the measurement cell 9. When the oscillation wavelength of the second LD 5 is appropriately set so that the absorption of light at that wavelength by the gas in the measurement cell 9 is negligibly small, there is no substantial difference in the amount of light between the laser beam passing through the measurement cell 9 and the laser beam bypassing this cell 9. Accordingly, even when the laser beam from the first LD 1 is mixed with the laser beam from the second LD 5 after its passage through the measurement cell 9 and the mixed beam is introduced into the photodetector 10, the obtained effect will be comparable to the effect obtained in the case of mixing the laser beams at a point before the measurement cell 9.

In the ease of FIG. 2 or FIG. 6, the second LD 5, which is not used for the concentration measurement, does not need to be a tunable laser diode. For example, it may have a fixed wavelength as long as its amount of emission changes with the drive current. It is evident that, even if the wavelength of the laser beam emitted from the second LD 5 is fixed, the major step-like change in the output of the photodetector 10 associated with the wavelength-switching can be prevented if the amount of emission of the second LD 5 is controlled so that it changes at a timing synchronized with the saw-tooth change in the amount of emission of the first LD 1 corresponding to the wavelength-sweep operation and in an inverted saw-tooth form in which the amount of emission oppositely changes. Using a laser diode having a fixed wavelength is advantageous for reducing the amount of increase in the cost of the device.

The configuration shown in FIG. 1 is intended for simultaneously measuring two components, while the configurations shown in FIGS. 2 and 6 are intended for measuring one component. It is easy to further increase the number of LDs to create a configuration for simultaneously measuring three or more components. FIG. 5 is a configuration diagram of an optical system of a gas concentration measurement device designed for simultaneously measuring three components. The parts enclosed in broken line A′ are the parts added to the conventional device. In this example, the laser beam emitted from the first LD 1 passes through the first ND filter 3, the first half mirror 4 and the second half mirror 33 in this order, to be thrown into the measurement cell 9. The laser beam emitted from the second LD 5 initially passes through the second ND filter 7, after which it is reflected by the mirror 8 and the first half mirror 4, to be thrown into the measurement cell 9 after passing through the second half mirror 33. The laser beam emitted from the third LD 30 initially passes through the third ND filter 31, after which it is reflected by the mirror 32 and the second half mirror 33, to be thrown into the measurement cell 9.

The first and third LDs 1 and 30 are respectively supplied with synchronized drive currents each having a saw-tooth waveform for the wavelength-sweep operation, while the second LD 5 is supplied with an inverted saw-tooth drive current synchronized with the aforementioned saw-tooth waveform. Each drive current has a modulating current of a different frequency superimposed thereon. The laser beam thrown into the measurement cell 9 is a composite of three laser beams, including two beams whose amount of light changes in the saw-tooth form and one beam whose amount of light changes in the inverted saw-tooth form. The DC level of the output of the photodetector 10 can be smoothed by appropriately setting the light-attenuating characteristics of the ND filters 3, 7 and 31.

The S/N ratio of the signal obtained by phase-sensitive detection, which includes a peak wave originating from a target component, will become higher as the amount of light of the laser beam used for analyzing the target component increases. Therefore, in the process of adjusting the amount of light by ND filters, it is preferable to increase the amount of light of the laser beam used for a component whose concentration needs to be determined with high accuracy, and to relatively decrease the amount of light of the laser beam used for a component whose concentration does not need to be accurately calculated. Accordingly, the wavelength-changing direction in the wavelength-sweep operation and the light-attenuating characteristic of each ND filter should be appropriately determined according to the kind of the target component and the required accuracy.

It should be noted that the previous embodiments are mere examples of the present invention, and any change, modification or addition appropriately made within the spirit of the present invention will naturally fall within the scope of claims of this patent application. For example, it is obvious that the half mirrors used for mixing a plurality of laser beams in the previous embodiments may be replaced by fiber couplers or other optical elements.

### EXPLANATION OF NUMERALS

1, 5, 30 . . . Tunable Laser Diode (LD)
2, 6 . . . LD Driver
3, 7, 31 . . . ND Filter
8, 32 . . . Mirror
4, 33 . . . Half Mirror
9 . . . Measurement Cell
10 . . . Photodetector
11 . . . Amplifier
13, 15 . . . Phase-Sensitive Detector
14, 16 . . . Digital Low-Pass Filter (DLF)
17 . . . Data Processor
18 . . . Output Unit
20, 23 . . . Modulation Oscillator
21 . . . Normal Saw-Tooth Scan Oscillator
22, 25 . . . Adder
24 . . . Inverted Saw-Tooth Scan Oscillator

1. A gas concentration measurement device for measuring a concentration of a specific component in a gas by a tunable diode laser absorption spectrometry measurement, comprising:
a) a plurality of laser sources, including a first laser source having a variable wavelength;
b) a laser drive controller for supplying a drive current to the first laser source so as to modulate an oscillation wavelength of the first laser source at a predetermined modulation frequency and repeatedly sweep, in a predetermined waveform, a predetermined wavelength range including an absorption wavelength of a target component, and for supplying a drive current to another one of the laser sources so as to change an amount of emission of this other one of the laser sources in an inverse waveform in which the amount of emission repeatedly changes in synchronization with a wavelength sweep in the predetermined waveform and with a growing manner opposite to a change in the amount of emission associated with the wavelength sweep;
c) a measurement cell for holding a gas to be analyzed, the measurement cell being positioned so that a laser beam emitted from the first laser source is thrown into the measurement cell;
d) a light mixer for mixing a plurality of laser beams respectively emitted from the plurality of laser sources to be thrown into the measurement cell, or for mixing a plurality of laser beams respectively emitted from the plurality of laser sources including at least one laser beam that has passed through the measurement cell and at least one laser beam that has bypassed the measurement cell;
e) a photodetector for receiving a mixed laser beam produced by the light mixer, the mixed laser beam being composed of a plurality of laser beams respectively emitted from the plurality of laser sources, with at least one laser beam passing through the measurement cell; and
f) a demodulator for extracting a fundamental component of the modulation frequency or a harmonic component of the modulation frequency by phase-sensitive detection from a detection signal obtained with the photodetector,
where the change in the amount of emission associated with the wavelength sweep in the predetermined waveform and the change in the amount of emission in the inverse waveform cancel each other at a stage where the laser beams are mixed by the light mixer and the mixed laser beam is received by the photodetector, so that an output change corresponding to the wavelength sweep is smoothed at an output stage of the photodetector.

2. The gas concentration measurement device according to claim 1, wherein the change in the amount of emission associated with the sweep of the oscillation wavelength of the first laser source is made to occur in a saw-tooth form, while the change in the amount of emission of the aforementioned other one of the laser sources is made to occur in an inverted saw-tooth form which has an opposite changing direction.

3. The gas concentration measurement device according to claim 1, further comprising a light attenuator for reducing an amount of light is provided between at least one of the laser sources and the light mixer located before the measurement cell or between the measurement cell and the light mixer located after this measurement cell, so that the output change associated with the wavelength sweep is smoothed at the output stage of the photodetector.

4. The gas concentration measurement device according to claim 2, further comprising a light attenuator for reducing an amount of light is provided between at least one of the laser sources and the light mixer located before the measurement cell or between the measurement cell and the light mixer located after this measurement cell, so that the output change associated with the wavelength sweep is smoothed at the output stage of the photodetector.

5. The gas concentration measurement device according to claim 1, wherein:
the plurality of laser sources are two, first and second laser sources each having a variable wavelength;
the laser drive controller supplies a drive current to the second laser source so as to modulate an oscillation Wavelength of the second laser source at a second modulation frequency different from the aforementioned predetermined modulation frequency and repeatedly sweep a predetermined wavelength range including an absorption wavelength of a second target component; and
the gas concentration measurement device comprises a second demodulator for extracting a fundamental component of the second modulation frequency or a harmonic component of the second modulation frequency by phase-sensitive detection from a detection signal obtained with the photodetector.

6. The gas concentration measurement device according to claim 2, wherein:
the plurality of laser sources are two, first and second laser sources each having a variable wavelength;
the laser drive controller supplies a drive current to the second laser source so as to modulate an oscillation wavelength of the second laser source at a second modulation frequency different from the aforementioned predetermined modulation frequency and repeatedly sweep a predetermined wavelength range including an absorption wavelength of a second target component; and
the gas concentration measurement device comprises a second demodulator for extracting a fundamental component of the second modulation frequency or a harmonic component of the second modulation frequency by phase-sensitive detection from a detection signal obtained with the photodetector.

7. The gas concentration measurement device according to claim 3 wherein:
the plurality of laser sources are two, first and second laser sources each having a variable wavelength;
the laser drive controller supplies a drive current to the second laser source so as to modulate an oscillation wavelength of the second laser source at a second modulation frequency different from the aforementioned predetermined modulation frequency and repeatedly sweep a predetermined wavelength range including an absorption wavelength of a second target component; and
the gas concentration measurement device comprises a second demodulator for extracting a fundamental component of the second modulation frequency or a harmonic component of the second modulation frequency by phase-sensitive detection from a detection signal obtained with the photodetector.

8. The gas concentration measurement device according to claim 4 wherein:
the plurality of laser sources are two, first and second laser sources each having a variable wavelength;
the laser drive controller supplies a drive current to the second laser source so as to modulate an oscillation wavelength of the second laser source at a second modulation frequency different from the aforementioned predetermined modulation frequency and repeatedly sweep a predetermined wavelength range including an absorption wavelength of a second target component; and
the gas concentration measurement device comprises a second demodulator for extracting a fundamental component of the second modulation frequency or a harmonic component of the second modulation frequency by phase-sensitive detection from a detection signal obtained with the photodetector.
